(19) United States
(12) Patent Application Publication
(10) Pub. No.: US 2011/0272358 A1
(43) Pub. Date: Nov. 10, 2011

(54) Media compaction compensating support system for pollutant stream remediation reactors

(76) Inventors: Martin Crawford, Stateline, NV (US); Jeff Jones, Belton, TX (US)

(21) Appl. No.: 12/800,113

(22) Filed: May 10, 2010

(51) Int. Cl. B01D 39/16; B01D 53/02; B01D 15/04

(52) U.S. Cl. 210/660; 210/226; 210/788; 55/524; 96/149; 95/274; 95/90

(57) ABSTRACT

The present invention discloses a method of forming a media support wall framework having a graduated through/pore space of the framework wall such that the graduation provides a greater through space in the lowest region of the framework; providing thus an entry plenum pressure differential compensation that compensates for media compaction problems associated with media contained in vertically standing remediation units; thus providing a more equalized passage of a contaminated air or water stream in a radial direction through out the full height of the media bed and assuring more efficient use of the contained media.

### BACKGROUND OF THE INVENTION

1. Field of Invention

The invention relates to an apparatus and process used for removing pollutants from a contaminated air or liquid stream “stream” in which a media support wall “framework” is designed to compensate for the problems commonly associated with media compaction in vertically standing radial flow contaminated stream purification systems “reactors”; the framework and a media being supported are integral but not unitary.

More particularly it relates to a method of proportioning a set of openings “through spaces aka pore spaces” located within a cylindrical or multifaceted framework formed of a fiberglass reinforced plastic “FRP”, or another such corrosion resistant material such as plastic that has been woven in a diamond shaped open weave lattice pattern in such a manner that through spaces of a greater diameter or surface area are found nearer a bottom level than at a top level of the framework walls.

2. Description of the Relevant Prior Art

A typical treatment of contaminant containing streams involves passing the stream through a reactive media in a media containment structure framework situated within a vertically standing, radial flow plenum which serves as a reactor housing section of a reactor system.

Issues include plenum size, choice of material, energy consumption and media compaction. In instances where the incoming stream contains corrosive gases, the materials used to form the containment structure are chosen to be as non-reactive as possible. This need has traditionally placed a limitation upon the size of media containment structures.

Used alone as inert structural materials, plastics do not have the structural strength for creating large structures. Metals have the strength but corrode too easily. One successful application involves the use of corrosion resistant FRP to overcome both the issues of non-reactivity and the issue of adequate strength to meet the structural demand in large commercial applications. The design allows of filtration at an ambient or slightly above ambient air pressure and hence provides excellent energy efficiency, while, being compatible with increased pressures when the needs demand such a unit.

The FRP walls can serve alone as the support wall component in a use for media such as foam or reticulated foam, or, alternatively, can be woven with an integrated central layer of corrosion resistant screen material sandwiched between an internal and an external layer of FRP, such that the screen material fills the FRP wall through spaces, providing thus a containment wall for granulated media such as activated charcoal, or media such as lava rocks or wood chips.

Over time, two differing reactor designs have emerged. The earlier reactors used a vertical flow of the incoming stream under pressure or vacuum, thus requiring a considerable consumption of energy in their operation. Vertically standing, radial flow reactors work at ambient or just above ambient pressures, requiring no compressors or vacuum units or expensive seals for their operation, thus presenting less potential for escape of untreated air into the environment.

In general, radial flow reactors consist of a containment vessel (a plenum) within which is located a series of baffles that separate the incoming polluted stream from the exiting purified stream. The space between the baffles holds and supports the remediation media. Commonly, the baffles consist of a pair of cylindrically shaped or multi-faceted frameworks, one having a smaller diameter than the other and being concentrically located within the former. These framework walls have open spaces “through spaces” through which the air passes into and then exits from the media contained between the frameworks.

Media compaction results in decreased efficiency of purification in all vertical, radial flow reactors, and especially in larger units for commercial applications. The weight of the media tends to compact the lower levels creating greater resistance to flow of the stream through these areas. This sometimes resulted in channelization wherein pathways of lesser resistance developed and the stream thus by passed other portions of the media. As the media settles, an open space will develop at the top of the media bed, allowing unpurified or less purified stream materials to pass through that area.

Solutions were varied, stratification into a series of shorter walled sections stacked upon each other was used; this involved greater cost of construction and increased costs of maintenance. Another solution of part of the problem was to create a solid wall section extending down from the top of the framework wall to where the top level of media was expected to settle over time.

On going pressure testing of the pressure at various levels of the stream entry inlet manifold of reactor plenums in devices currently being manufactured by the inventors revealed that the pressure was significantly lower at the topmost levels of the manifold of their reactor. It was postulated that it would therefore be easier for the incoming contaminated stream to move radially through the higher vs. the lower levels of media in the unit; and this was considered to be related to the increased density of the media in the lower levels of the media containment section of the plenum. A major negative result of this condition was that the greater flow through of the stream at the higher levels would lead to the upper portion of the media becoming spent and losing its remediation potential before the lower levels were equally used up; thus leading to removing and discarding the less than optimally used up portions of the media in the lower levels of the media containment section because the upper levels were already spent.

It was obvious that some manner of compensating for the loss of efficiency created by media compaction was needed; what was not obvious was how to achieve that end.

The present invention came to mind while considering the intra manifold pressure differentials and how to compensate for same in order to improve reactor efficiency.

### STATEMENT OF THE OBJECTIVES

Accordingly it is an object of this invention to create a framework, designed to compensate for media compaction problems and create more equalized utilization of media throughout the full vertical height of the reactor unit.

Another object is to provide a framework that equalizes the top to bottom entry manifold pressure and improves reactor efficiency.

Another objective is to provide a corrosion resistant media support framework for use in a radial flow reactor, said framework having the structural strength allowing for its use in large commercial and municipal reactors, yet also having a flexibility of design allowing for use in small sized reactors; at the same time providing support walls with a greater through space that allows remediation of a greater stream volume per unit of time relative to other comparably sized units; doing so with a low pressure drop from the inlet side to the outlet side of the media containment structure, thus simplifying installation and conserving energy.

Another object of the invention is to provide a containment structure that is equally suitable for use with a variety of media, including porous granular substrate media such as activated carbon, or media such as foam and reticulated foam.

Another object of this invention is to provide a containment structure design that allows fabrication such that the media supports can be retrofitted into existing reactors.

Other objectives, advantages and novel features of the invention will become apparent to those skilled in the art upon examination of the invention and the accompanying drawings.

### SUMMARY OF THE INVENTION

U.S. Pat. No. 3,162,516 “Dwyer” teaches a vaporous pollutant remediation filter process wherein a pressurized gas is received into an inlet of a plenum and flows radially through a remediation medium that is contained between concentrically arranged steel mesh cylinders having a diamond basket shaped weave pattern and a pore size that retains the purification medium between the mesh cylinders.

The present invention differs in two critical manners. Dwyer teaches a uniform weave and pore space throughout the cylinder, whereas the present invention specifically teaches both: a varied pore space and a specific location of the pore space variation. The limitation concerning pore space variation taught in this invention is based upon novel findings that solved a prior unrecognized but important problem.

Also there is a criticality to the preferred pore space in the present invention vs. Dwyer which teaches no “preferred” pore space. In Dwyer, the sole determinant of a pore space size is that the pore size be small enough to retain the purification medium. In the present invention the pore space, more correctly termed a “through” space needs to be as large as possible in order to provide a maximal air flow though the system, yet must allow of a solid framework component that satisfies the need for adequate stability of the media containment structure. In the present invention there may or may not be a screen having solely a pore feature created by a diamond shaped weave of wires as a pore is described in Dwyer. In the current invention, the framework that is woven in a diamond shaped pattern has openings much larger than would contain some media. In an embodiment where a self restraining media such as foam is used, there is no screen, only the diamond shaped support framework wall is needed; in an embodiment using carbon particle filtration, a secondary screen, not having diamond shaped pore spaces is used; in fact the pore spaces in the screen are circular in nature, totally out of conformation with Dwyer's device. The through space requirement differences between Dwyer and the current invention are significant and described in conjunction with the following discussion of U.S. Patent Application No. 2005/0126139A1 “Sewell”

Sewell teaches a high pressure filtration application. The preferred through space taught by the current invention is one of the major distinctions vs. Sewell. Part of the motivation for use of the FRP wall sandwich was to provide for a low pressure alternative to prior art models which required high pressure to force the air through the reactor. The prior art therefore involved use of expensive seals and pressurizing equipment, and increased risk of contaminated air breaching into the ambient environment. The maximal through space of their containment walls was approximately 50% as opposed to the 65% to 75% through space achievable with the current invention.

Sewell's design appears to be able to operate with a greater through space than the other prior art. Given that both Sewell and the current invention create through spaces greater than is found in the prior art, as opposed to Sewell, the through space component of the design of the current invention is not a stand alone factor. In the current invention the full equation includes the following: 1. maximal through space; in concert with 2. adequate structural strength to allow a free standing support capable of containing a large weight of media material without distortion, and 3. operation without the need for a high pressure air stream and the special fittings, gaskets and the increased costs and maintenance associated with handling high pressure air streams.

Lightweight mesh screens such as described by Sewell do not meet the strength requirements needed for the present application. U.S. Pat. No. 6,224,838 “Schulz, et al” and other such prior art used stronger wall materials and design (scalloped and punched openings) as was also described by Sewell; however, none of those disclosed prior art devices could achieve over a 50% through space limit using their means. It was the use of the FRP sandwich wall woven in a diamond shaped basket weave configuration that provided the combined elements of maximal through space, free standing structural strength and operational ability at slightly above ambient air pressure.

In Sewell, the only demand of the support wall is that the wall contain pores of a size small enough to contain the filtering material, and load bearing strength is not an issue. In the present invention which teaches an exceptional range of sizes of filter plenums, in order to maximize efficiency of the filtering system, the through space should be maximized to the greatest extent possible within a wall material having load bearing strength sufficient to withstand the weight of a large and heavy media that is being contained.

U.S. Pat. No. 6,221,320 “Nagaoka” teaches a media containment segment within a freestanding plenum in which a series of vertically standing independent segments are aligned circumferentially around the periphery of an air outlet manifold; the design being created to provide a substantially constant thickness of media between the inner and outer walls of the media bed section and a constant width between the inner and outer walls at top, central and lower sections of the media bed wall. This improvement compensated for a tendency for the mid height portions of the media containment frameworks of the then prior art models to bow apart under the weight of the enclosed media. That deformation led to an uneven lateral thickness of media and an uneven flow of the contaminated stream leading to uneven filtration at different levels of the reactor.

The present invention not only duplicates Nagaoka's provision of a non-bowing central framework area, it goes beyond Nagaoka and provides for compensation for uneven filtration secondary to media compaction, a problem Nagaoka mentions but fails to explain a solution for; the issue of media density due to a constant width of media being his concern. Despite maintaining the desired even media width between the inner and outer walls of his catalyst containers, each of his plurality of vertically arranged, independent and free standing catalyst containers (media beds) would still be subject to a compaction problem relative to the weight of the media, leading to a greater density of media at a lowest versus a lesser density at a highest level of the containment vessel. This unrecognized, but measurable and real problem is what is addressed by the current invention.

The present invention involves the creation of a media support system in which a pair of framework walls designed to hold a media between them are proportioned in a manner that compensates for the media compaction problem associated with radial flow reactors. The device created by the invention comprises a support for housing a filter material, and is not a filter or a filtering agency itself; compensation for the compaction of media is provided by using through spaces having a larger surface area in the lower portion of the framework wall, a level of the containment structure where there is greater media compaction and density; through spaces having a smaller surface area are located in the upper portion of the containment walls where the media is less dense; this leads to more equalized pressure throughout the full height of the stream inlet manifold of the reactor which improves both media utilization and provides more equally effective contaminant removal from the incoming stream at the various levels of the containment structure.

### BRIEF DESCRIPTION OF THE DRAWINGS

Further objectives and advantages of the invention will be apparent from the following detailed description when taken in conjunction with the accompanying drawings illustrating a preferred embodiment of the invention. The drawings are:

FIG. 1A. Presents a horizontal view looking down onto the top of a media support framework, which said framework partially comprises an internal and an external fiberglass reinforced plastic or plastic framework component between which is sandwiched a fused, centrally situated screen made of a corrosion resistant material.

FIG. 1B. Presents a diagrammatic side view of a section of a media support framework wall.

FIG. 1C. Presents a frontal, diagrammatic view of a media support framework wall showing preferred pattern of many possible differential grading pattern of individual through space opening sizes at the lower and upper levels of the framework wall.

FIG. 1D. Presents a horizontal view looking down onto the top of a media support framework, which said framework comprises an internal and an external fiberglass reinforced plastic or plastic framework component.

FIG. 2. Presents a vertical cross section at the vertical axis center of a radial-flow air remediation system plenum.

FIG. 3A. Presents a view looking down at the top of the removable top plate of a remediation system plenum.

FIG. 3B. Presents a view of the under side of the top plate of the plenum.

### DETAILED DESCRIPTION OF A PREFERRED EMBODIMENT

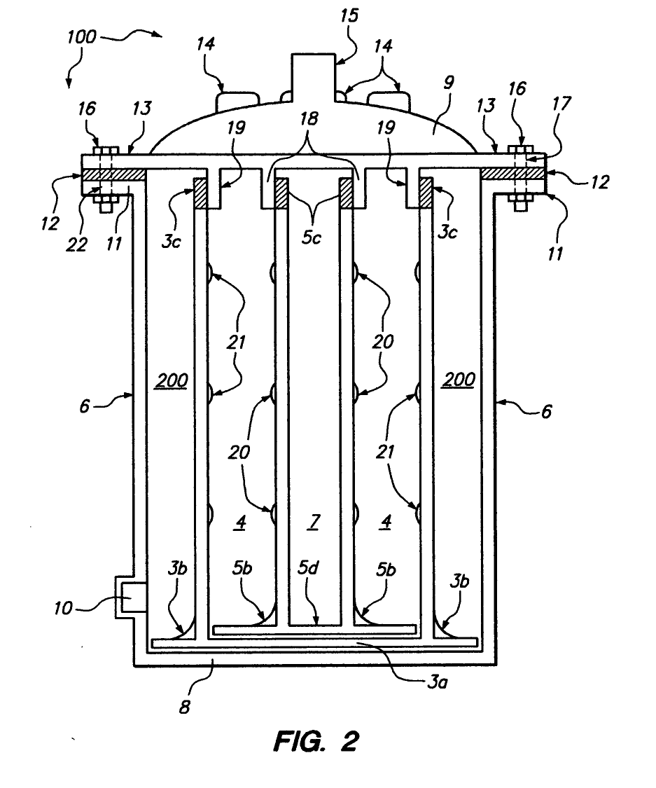

The invention, a device, presents an improvement wherein a media support system comprising in part a pair of concentrically arranged media support frameworks/“frameworks” 3, 5 FIG. 2, which said frameworks act as a pair of media containment section walls of a media containment section 4 FIG. 2 of a vertically standing radial flow air or liquid stream remediation reactor plenum/“reactor” 100 FIG. 2, in which a media is used for a remediation of a contaminated air or liquid stream/“a stream” following a passage of said stream through said media in a flow at a ambient or slightly above ambient air pressure; said stream comprising a single or a combination of corrosive or non-corrosive, toxic contaminants; said frameworks each being of a cylindrical or a multifaceted shape and of a differing diameter, and being situated with a framework of a lesser diameter, a smaller, inner framework 5 FIG. 2, standing within a framework of a greater diameter, a larger, outer framework 3 FIG. 2; and, said frameworks being arranged in a coaxial alignment between themselves 3, 5 FIG. 2 and relative to a sidewall 6 FIG. 2 of said reactor.

### First, Preferred Embodiment

### For a Granulated Media

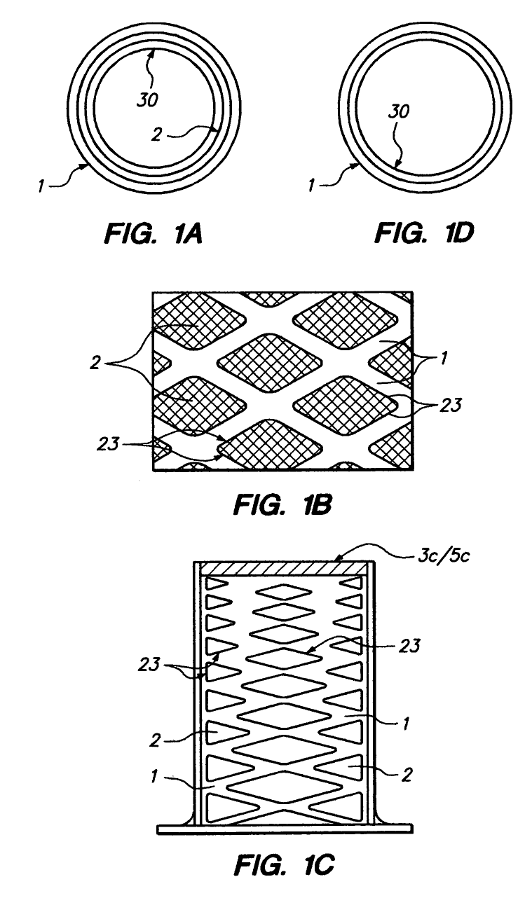

In a first, preferred embodiment, designed to provide a support of a granular, porous substrate media, such as an activated charcoal media or an organic media such as a lava rock or a wood chips media, as viewed from above: either of said inner or outer framework wall/s 3, 5 FIG. 1A are seen to comprise a sandwich in a fixedly fused state comprising a set of three layers 1,2,30 FIG. 1A, a central layer comprising a corrosion resistant screen material 2 FIG. 1A being held in a fixedly fused state between a superimposed external wall layer 1 FIG. 1A comprising a corrosion resistant fiberglass-reinforced plastic “FRP”, or, a corrosion resistant material such as plastic; and an internal wall layer of corrosion resistant FRP or, a corrosion resistant material such as plastic 30 FIG. 1A; said central layer of said corrosion resistant screen material being held in a fixedly fused manner between said superimposed internal layer and external layers of said FRP or alternatively between said superimposed internal layer and external layers of said corrosion resistant material such as plastic.

Seen in a sectional side view of said first preferred embodiment, said framework wall is seen to comprise a basket weave diamond shape lattice framework wall component of solid FRP 1 FIG. 1B or of, a corrosion resistant material such as plastic; said framework wall further comprising in part a series of openings, also known as and hereinafter referred to as through spaces/“through spaces” 23 FIG. 1B said through spaces being found in a location between each of said woven, solid-FRP diamond shaped lattice framework wall component sections. For a use in said support of said porous granular substrate media or said organic media, said screen material 2 FIG. 1B comprises a pore size slightly smaller than a granule size of the units of said media contained in said media containment section 4 FIG. 2 of said reactor 100 FIG. 2.

Said diamond shaped continuous basket weave form of said solid-FRP support frameworks providing, in the aggregate, for a solid-surface FRP wall component comprising approximately a 32 percent portion relative to a total wall surface area of said FRP framework walls, and a through space averaging a 68 percent portion relative to said total wall surface area of said FRP framework walls; said central layer of corrosion resistant plastic screen material 2 FIG. 1A,B,C having a pore size comprising approximately a 50 percent portion of a total surface area of said screen material, thus, in a combination with said external and internal open weave FRP wall sections, leading to a combined through space of approximately 34 percent by a consideration of said FRP wall in a combination with said screen portion of said total surface area of said support framework wall while creating an exceptional structural strength of said walls.

Alternative Embodiment for Non-Granular Media

In an alternative embodiment suitable for a support of a non-granular, inorganic media, such as a foam media, or a reticulated foam media, as viewed from above, said framework wall/s 3, 5 FIG. 1D are seen to comprise a sandwich in a fixedly fused state formed of a set of at least two layers 1,30 FIG. 1D; at least one superimposed external layer 1 FIG. 1D, said layer comprising either an FRP component, or, a corrosion resistant material such as plastic, and; an internal layer 30 FIG. 1D comprising a corrosion resistant FRP or, a corrosion resistant material such as plastic; said external and internal layers being fused to form a unitary framework wall.

Seen in a sectional side view, said alternative external framework wall comprises a basket weave diamond shape lattice framework wall component of FRP or, a corrosion resistant material such as plastic 1 FIG. 1C; a series of openings, also known as and hereinafter referred to as through spaces “through spaces” 23 FIG. 1C being found in a location between each of said woven FRP diamond shaped lattice pattern components; it is to be noted that since the media types being supported in this said alternate embodiment are structurally unitary and non-granular, there is no need for a central screen layer in this alternate embodiment.

Said alternative embodiment frameworks, comprising only a basket weave FRP framework wall component, present with approximately a 68% through space of a total framework wall area of said unitary framework wall.

Selective Size Gradation of Through Spaces

Of utmost importance as the basic foundation for the claimed novelty and functional improvement brought about by this invention, regardless of the embodiment; whether for said porous, granular media or said foam media, said through spaces 23 FIG. 1C in said framework walls are: of a selectably, differentially graded size and arranged such that a wall section in a lower portion of said framework wall has a larger total area of through space than is found in an equivalent length of wall section in an upper portion of said framework wall; said differential gradient of said through spaces acting to provide a more equal rate of flow for a passage of said contaminant laden air or liquid stream in a radial flow direction throughout a full vertical length of said media containment section, and providing an improved utilization of said media.

In the absence of said differential through space gradient, there would exist an imbalanced rate of flow into and through said media in said containment section, said imbalanced flow being a negative effect caused by a compaction of said media that leads to an increased media density and resistance to stream passage in the lower levels of said media containment section 4 FIG. 2 of said reactor; said through space differential gradient creates a greater resistance to radial flow through said framework walls at an upper level than exists at a lower level of said wall; thus, this improved framework design/configuration balances a top to bottom pressure differential gradient otherwise known to be found within a stream entry manifold 200 FIG. 2 of said reactor plenum 100 FIG. 1; in the absence of such said through space gradation, a higher pressure is to be found within a lower level than within a higher level of said entry manifold 200.

In order to further prevent a passage of an unremediated, contaminated air or liquid stream into the environment, said FRP walls also partially comprise a predetermined solid topmost section comprising a solid top band having no through spaces 3c, 5c FIG. 1C; said top band being of a vertical height sufficient to compensate for a creation of a media free space at a top level of said media containment section caused by said compaction of said media over time. Said differentially gradiented framework wall and said solid top band, serving in concert to optimize the efficiency of a remediation of a contaminated air or water stream, thereby maximally providing an increased efficiency of utilization of said media in said reactor.

A like extrusion pattern of which said internal layer 30 FIG. 1a and external layer 1 FIG. 1a of said framework, whether such extrusion includes an envelopment of a central screen section 2 FIG. 1a, or whether such extrusion be only of said superimposed FRP internal and external walls 30 and 1 FIG. 1a, said extrusion leads to said external framework wall being superimposed throughout a full vertical length over the same framework pattern as is said internal wall framework such that said overall through space for said combined components of said framework is as has been described immediately prior. Said frameworks being designed and fabricated in an appropriate shape and an appropriate size according to a specific need of a given remediation plenum.

### Plenum/Reactor

When viewing a vertical cross section at a longitudinal center of said reactor 100 FIG. 2; said media containment section 4 FIG. 2, is bounded externally by said outer FRP wall 3 and internally by said inner FRP wall 5; said media containment, section 4 being designed to contain said media—not shown—capable of remediating said contaminated stream of said contaminants that are carried to it in said stream; said stream, in a flowing at a ambient or just above ambient air pressure, enters into said plenum of said reactor though a contaminated stream inlet 10 FIG. 2 following which said stream, moving in a radial flow direction, enters a stream inlet manifold 200 FIG. 2, a lateral wall of which said stream inlet manifold is formed by an inner aspect of said side wall 6 of said reactor. Said framework support walls 3 & 5 FIG. 2 are in an alignment coaxially between themselves and with said vertically standing lateral wall 6 FIG. 2 of said reactor, thus providing for a uniform thickness of said media in a radial direction between said stream entry manifold side 200 FIG. 2 and a remediated stream outlet-manifold side 7 FIG. 2 of said reactor throughout a full vertical length of said media containment section 4 FIG. 2, providing an improved utilization of said media thereby.

After entering said air inlet manifold, said contaminated stream next makes a radial passage through said outer FRP support framework wall 3 FIG. 2, then continuing in said radial direction said stream next makes a passage through said media containment section 4, next passing in a radial flow direction through said inner most FRP support framework wall 5, and into said treated stream outlet manifold 7 after which it makes an exit into the environment as a remediated stream through a remediated stream outlet 15 FIG. 2.

Said granular organic porous remediation media held between said frameworks 3 & 5 FIG. 2, commonly activated charcoal, but not limited to being activated charcoal, is commonly of a dimension of 3-4 mm in diameter, but could be larger or smaller dependent upon the needs of the'particular application.

By presenting a vertical cross section at the vertical axis center of said reactor 100 FIG. 2 as a preferred embodiment, FIG. 2 presents an example from which can be learned one method of aligning and supporting said FRP media support frameworks that are the foundation of this invention.

This example is not intended to represent nor should it be taken to be the sole manner of appropriately aligning and supporting said FRP frameworks, rather, it is presented to educate people familiar with the art as to a method of fabricating a reactor such that there is ease of introduction and removal of said FRP frameworks into said reactor as needed, and such that control of said stream pathway throughout said reactor presents minimal possibility of the escape of unremediated air into the environment while providing a maximal flow of said stream from said entry to said outlet side of said reactor with a minimal pressure drop between said entry and said outlet sides of said reactor.

Said reactor 100 FIG. 2 that contains said frameworks 3 & 5 FIG. 2 further partially comprises a floor section 8 FIG. 2 and a removable top plate section 9 FIG. 2.

Separate from said floor 8 FIG. 2 of said reactor said outer framework 3 has a separate, integral outer framework floor section 3a FIG. 2, said floor section comprising a full floor for said outer framework wall, which said full floor further comprises an integral circumferentially equal projection in a lateral direction towards and ending just short of an internal aspect of said wall of said plenum; said outer framework wall integral floor lateral projection section and said outer framework wall being brought into a reinforced conjoinment by a bonded, solid, circumferential floor to outer framework wall reinforcement band 3b FIG. 2; said reinforcement band being situated at a juncture of a top face of said floor projection and a lateral, base aspect of said outer wall framework.

Said inner framework 5 also comprising in part a separate, inner framework integral floor section 5a FIG. 2; said floor section forming a full floor of said inner framework wall, which said full floor further comprises an integral circumferentially equal projection in a lateral direction towards and ending just short of an internal aspect of said outer framework wall; said inner framework wall integral floor lateral projection section and said inner framework wall being brought into a reinforced conjoinment by a bonded, solid, circumferential floor to inner framework wall reinforcement band 5b FIG. 2; said reinforcement band being situated at a juncture of a top face of said floor projection and a lateral, base aspect of said outer framework wall framework.

An internally facing aspect of said outer framework wall 3 FIG. 2 being in a fused conjoinment with a series of three vertically separated circumferential outer framework reinforcement bands 21 FIG. 2, which said outer framework wall reinforcement bands provide a reinforcement preventing a lateral displacement and deformation of said outer framework that could other wise follow under a pressure of said weight of said media in said media containment section.

A laterally facing aspect of said inner framework wall 5 FIG. 2 being in a fused conjoinment with a series of three vertically separated circumferential inner framework reinforcement bands 20 FIG. 2, which said inner framework wall reinforcement bands provide a reinforcement preventing a central displacement and deformation of said inner framework that could other wise follow under a pressure of said weight of said media in said media containment section.

Said floor section 8 FIG. 2 that forms the bottom seal section of said reactor, is appropriately anchored by one of several means to an appropriate foundation section, and at its periphery is joined to said side wall 6 of said reactor, which side wall forms a lateral boundary of said stream entry manifold 200. Above, said side wall 6 FIG. 2 is continuous with a top collar section 11 FIG. 2 of said base section 6,8,11 FIG. 2 of said contaminated stream purification reactor.

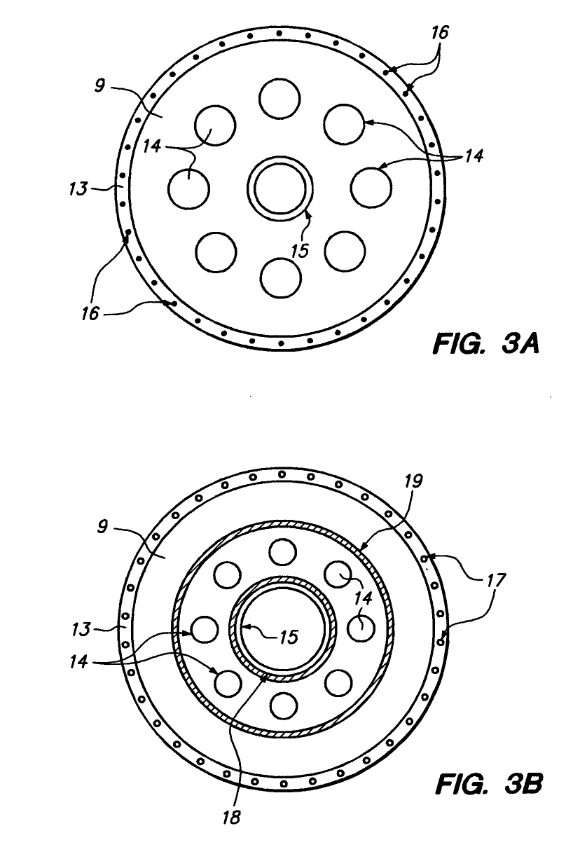

Said top collar section 11 FIG. 2 projection forms a seating element for a removable top plate seating flange 13 FIG. 2 of said top plate 9 FIG. 2, with a top plate seal gasket 12 FIG. 2 serving as a sealing element for a creation of an affixation in a sealed manner between said top plate seating flange 13 and said top collar flange 11; a series of bolt and nut sets 16 FIG. 2 also seen at 16 FIG. 3A serve to provide a means for an affixation in a sealed manner of said top plate to said base section of said plenum.

Removable top plate section 9 FIG. 2, has a set of removable top plate bolt holes 17 FIG. 3B, which said holes match a corresponding set of top collar bolt holes 22 FIG. 2, said sets of bolt holes serving to receive said bolt and nut sets 16.

A downward projecting inner framework top collar support ring 18 FIG. 2 of said removable top plate and a downward projecting outer framework top collar support ring 19 FIG. 2 serve to orient and maintain a top end of both of said framework walls in a proper vertical alignment, and serve as well, as a top level solid barrier having no through space; helping thus to provide an area of no through flow of air as a partial protection against the said negative effects of said media compaction. Further prevention of air flow through said top ends of said external and internal frameworks is in part ensured by a predetermined topmost section comprising a solid top band having no through space 3c/5c FIG. 2 seen at the tops of said frameworks, a solid outer framework top band 3C FIG. 2 and a solid inner framework top band 5C FIG. 2.

A series of man-way spin off tops 14 FIGS. 2, 3A, serve as a series of ports for an introduction or a removal of said remediation media such as granulated carbon (not shown) into said media space 4 FIG. 2. Said remediated stream outlet 15 FIG. 2 serves to allow an exiting, remediated stream to pass from said outlet manifold 7 into the environment.

The great strength and design flexibility created by this invention allow of creation of FRP frameworks for reactors ranging from very small to large to commercial/industrial size radial flow units. Current production has created reactors ranging from small units in which the FRP support frameworks were 4 feet tall, having an inner FRP framework internal diameter of 6 inches with the outer framework diameter being 3 feet; up to a very large unit, 20 feet tall with a inner FRP framework diameter of 7 feet and a outer FRP framework diameter of 11 feet. With respect to the larger construction mentioned above, it is the specific combination of materials and design elements created in this invention that allows of the creation of systems suitable for service in large scale industrial and commercial purification projects, such as were not possible utilizing the prior art.

Alternative Rate of Change of Through Space

In some applications, a user might need a varying pattern of alteration of through space sizes in said framework walls. To satisfy such a need, it is recognized that a series of alternative embodiments may be created in which, a programming of a diamond shaped weave pattern of said framework walls may be made to vary such that said gradient change of said through space areas can be made in a variable manner; in all of which said alternative embodiments a predetermined topmost section comprising a solid wall section of an appropriate vertical height is present to compensate for said loss of height of said media due to said compaction of same; further, in a most common embodiment; there may be a continuous progressively even lessening of through space size from said bottom to said top of said framework; or, alternatively, there may be a continuous and progressively uneven lessening of through space size from said bottom to said top of said framework in which an initially continuous and even lessening is followed at some point by a sudden change to a more rapidly accelerating section of lessening through space size; a third embodiment might display a discontinuous and progressively even lessening of through space size from said bottom to said top of said framework, wherein a lower most section is formed having a series of equal through spaces throughout a given vertical height of said wall, following which there is a progressively even lessening of said through spaces as said wall continues upwards; in still another embodiment there may be a discontinuous and progressively uneven lessening of said through space size from said bottom to said top of said framework in which a section having an initially equal through space size progressing along a given vertical height of said wall is followed at some point, by a section displaying a continuous progressively even lessening of through space size that is in turn supplanted by a section exhibiting a sudden change to a rapidly accelerating section of decreasing through space size.

### OTHER CONSIDERATIONS CONCERNING THE INVENTION

Even though non-fiberglass reinforced plastics do not have the degree of structural strength a similarly sized FRP element would have, plastics, being a corrosion resistant material, could be afforded a use to make larger frameworks; however, to do so the basket weave wall elements would have to be of a thicker and wider dimension, thus yielding a lower proportion of through space than would be provided by an FRP framework for a similar sized plenum, and thus leading to a reduction of the through space relative to the through space in a FRP framework for a similar sized plenum. Hence FRP is the preferable material because 1. it provides for a greater rate of flow though the media bed and 2. does so with a less pressure drop between the inlet and out let sides of the media bed, 3. as well as allowing of an increased efficiency of energy use because of the greater through space afforded by the FRP wall.

Metals, being of a less corrosion resistant nature are less desirable than either FRP or non-FRP Plastics for use in creating media frameworks for reactors purifying corrosive streams; being of a heavier nature, metals used in media containment frameworks create a need for a heavier foundation and other such expensive preparations.

What is claimed is:

1. In a vertically standing, radial flow air or liquid stream remediation reactor, a device, a media containment section; said media containment section containing a media designed to provide a remediation of a contaminated liquid or air stream by a passage of said stream through said media contained within said media containment section of said reactor, said plenum comprising in part, a side wall, a floor and a removable top plate section;
said media containment section comprising in part a pair of media containment section walls, said media containment section walls comprising in part a basket weave, diamond shape walled lattice pattern framework component, a series of openings or through spaces being found in a location between each of said diamond shaped lattice pattern components of said woven fiberglass reinforced plastic diamond shape walled lattice sections;
said frameworks being of a cylindrical or multifaceted configuration and of a differing diameter and being situated with a framework of a lesser diameter, a smaller, inner framework standing within a framework of a greater diameter, a larger, outer framework; and, said frameworks being in a coaxial alignment between themselves and relative to said sidewall of said plenum;
said outer framework further comprising in part an integral outer framework floor section said floor section comprising a full floor for said outer framework wall, which said full floor further comprises an integral circumferentially equal projection in a lateral direction towards and ending just short of an internal aspect of said side wall of said plenum; said outer framework wall integral floor lateral projection section and said outer framework wall being brought into a reinforced conjoinment by a bonded, solid, circumferential floor to outer framework wall reinforcement band; said reinforcement band being situated at a juncture of a top face of said floor projection and a lateral, base aspect of said outer framework wall;
said inner framework further comprising in part an integral inner framework floor section said floor section forming a full floor of said inner framework wall, which said full floor further comprises an integral circumferentially equal projection in a lateral direction towards and ending just short of an internal aspect of said lateral framework wall; said inner framework wall integral floor lateral projection section and said inner framework wall being brought into a reinforced conjoinment by a bonded, solid, circumferential floor to inner framework wall reinforcement band; said reinforcement band being situated at a juncture of a top face of said floor projection and a lateral, base aspect of said outer framework wall;
said through spaces of said media containment section framework walls being of a selectably, differentially graded size arranged such that a wall section in a lower portion of said framework wall has a larger total area of through space than is found in an equivalent length of wall section in an upper portion of said framework wall; said gradation of said through space sizes designed to balance a top to bottom pressure gradient differential in a stream entry manifold of said purification reactor, said pressure differential gradient being created otherwise by a compaction of said media in said media containment bed; said differently graded size though spaces in said framework walls thus providing a more equal rate of flow of a contaminant laden air or liquid stream through said media throughout a full vertical length of said media containment section and providing an improved utilization of said media thereby.

2. The frameworks of claim 1 in which a predetermined topmost section of said framework walls also partially comprises a solid top band having no through spaces, said top band being designed to prevent a passage of an unremediated, contaminated air or liquid stream through a top level of said media containment section within which said section said media compaction has resulted in a creation of a media-free space at said top level of said media containment section.

3. The lattice portion of said framework walls of claim 1, in an alternative embodiment intended for use as a support of a non-granular, inorganic media such as a conventional foam or a reticulated foam media, comprising in part a sandwich in a fixedly fused state comprising an internal layer and at least one superimposed external layer, said internal and said external layers being comprised of a fiberglass reinforced plastic material; said fused sandwich wall providing a total through space of an approximately 68 percent of a total surface area of said framework walls.

4. The lattice portion of said framework walls of claim 1 intended for a support of a granular, porous substrate media such as an activated charcoal media, or an organic media such as a lave rock or a wood chip media, in which said framework wall comprises in part a sandwich in a fixedly fused state comprising a central layer of a corrosion resistant screen material which said screen material is held between a superimposed internal layer and external layer of said fiberglass reinforced plastic material, said framework wall providing a total through space comprising an approximately 34 percent of a total surface area of said framework wall; said fused central layer of corrosion resistant screen material having a pore space size slightly smaller than a granule size of said granular porous substrate media or of said organic media.

5. The outer framework of claim 1 in which an internally facing aspect of said outer framework wall comprises in part a fused conjoinment with a series of three vertically separated circumferential outer framework wall reinforcement bands, which said outer framework wall reinforcement bands provide a reinforcement preventing a lateral displacement and deformation of said outer framework that could other wise follow under a pressure of said weight of said media in said media containment section.

6. The inner framework of claim 1 in which a laterally facing aspect of said inner framework wall comprises in part a fused conjoinment with a series of three vertically separated circumferential inner framework wall reinforcement bands, which said inner framework wall reinforcement bands provide a reinforcement preventing a central displacement and deformation of said inner framework that could other wise follow under a pressure of said weight of said media in said media containment section.

7. The plenum of said purification reactor of claim 1 further comprising a contaminated air or liquid stream inlet, a stream inlet manifold section, a remediated stream outlet manifold, a remediated stream outlet, an inner framework top support ring, an outer framework top support ring, a top collar section of said side wall, and, means for creating an affixation in a sealed manner of said top plate to said top collar section of said side wall of said plenum; and a series of man way spin off tops, which said spin off tops serve as a series of ports allowing of an introduction or a removal of said media from said media section of said reactor.

8. The lattice portion of said framework walls of claim 1 in which said framework walls comprise in part a sandwich in a fixedly fused state comprising an internal layer and at least one superimposed external layer, said internal and said external layers being comprised of a corrosion resistant material such as plastic; said fused sandwich wall providing a total through space of an approximately 68 percent of a total surface area of said framework walls; thus being suitable for a support of a non-granular, inorganic media such as a conventional foam media or a reticulated foam media.

9. The lattice portion of said framework walls of claim 1 in which a central layer of a corrosion resistant screen material is held in a fixedly fused state between a superimposed internal layer and external layer of a corrosion resistant material such as plastic; in combination, said fused sandwich fiberglass reinforced plastic framework wall and said fused central layer of corrosion resistant screen material providing a total through space comprising an approximate 34 percent of a total surface area of said framework walls; said fused central layer of corrosion resistant screen material having a pore space sized slightly smaller than a diameter of a granular porous substrate media such as an activated charcoal media, or an organic media such as a wood chips or lava rock media, said screen material thus, in combination with said fiberglass reinforced plastic wall of said framework, being suitable for a support of said granular porous substrate media.

10. The diamond shaped weave pattern walls of the frameworks of claim 3 in which in a series of alternative'embodiments, a programming of a diamond shaped weave pattern of said framework walls may be made to vary such that said gradient change of said through space areas can be made in a variable manner; in all of which said alternative embodiments a predetermined topmost section comprising a solid wall section of an appropriate vertical height is present to compensate for said loss of height of said media due to said compaction of said media; further, in a most common embodiment there may be a continuous progressively even lessening of through space size from said bottom to said top of said framework; or, alternatively, there may be a continuous and progressively uneven lessening of through space size from said bottom to said top of said framework in which an initially continuous and even lessening is followed at some point by a sudden change to a more rapidly accelerating section of lessening through space size; a third embodiment might display a discontinuous and progressively even lessening of through space size from said bottom to said top of said framework, wherein a lower most section is formed having a series of equal through spaces throughout a given vertical height of said wall, following which there is a progressively even lessening of said through spaces as said wall continues upwards; in still another embodiment there may be a discontinuous and progressively uneven lessening of said through space size from said bottom to said top of said framework in which a section having an initially equal through space size progressing along a given vertical height of said wall is followed at some point, by a section displaying a continuous progressively even lessening of through space size that is in turn supplanted by a section exhibiting a sudden change to a rapidly accelerating section of a decreasing through space size.

11.-12. (canceled)

13. A process allowing of a remediation of a contaminated air or liquid stream:
by a passage of said contaminated air or liquid stream, at a ambient or slightly above ambient air pressure, through a contaminated air or liquid stream inlet into an inlet manifold of a vertically standing, radial flow stream remediation plenum then in a radial flow direction through a pair of concentrically arranged media support frameworks of differing diameters, a smaller inner framework and a larger outer framework;
said support frameworks comprising in part a basket weave, diamond shape lattice pattern framework wall component; said framework components of said framework wall comprising a fixedly fused sandwich formed from an internal layer and at least one external layer of a Fiberglass Reinforced Plastic (FRP) material; a total through space of said FRP wall materials comprising an approximately 68 percent of a total surface area of said framework walls;
following said movement of said contaminated stream into said inlet manifold of said plenum, said stream passes in a radial flow direction through said outer framework wall and into a media containment section containing a media, said media comprising an inorganic media such as, foam or reticulated foam;
following a radial passage of said stream through said media, said stream, continues in a radial direction centrally through said inner framework wall and into a remediated stream outlet manifold of said plenum; said stream now comprising a remediated stream, which said remediated stream next makes an exit into the environment through a remediated stream outlet.

14. The frameworks of claim 12 in which said framework components of said framework walls comprise a corrosion resistant material such as plastic.

15. The frameworks of claim 13 in which said framework components of said framework walls comprise a corrosion resistant material such as plastic.

16. The diamond shaped weave pattern walls of the frameworks of claim 4 in which in a series of alternative embodiments, a programming of a diamond shaped weave pattern of said framework walls may be made to vary such that said gradient change of said through space areas can be made in a variable manner; in all of which said alternative embodiments a predetermined topmost section comprising a solid wall section of an appropriate vertical height is present to compensate for said loss of height of said media due to said compaction of said media; further, in a most common embodiment there may be a continuous progressively even lessening of through space size from said bottom to said top of said framework; or, alternatively, there may be a continuous and progressively uneven lessening of through space size from said bottom to said top of said framework in which an initially continuous and even lessening is followed at some point by a sudden change to a more rapidly accelerating section of lessening through space size; a third embodiment might display a discontinuous and progressively even lessening of through space size from said bottom to said top of said framework, wherein a lower most section is formed having a series of equal through spaces throughout a given vertical height of said wall, following which there is a progressively even lessening of said through spaces as said wall continues upwards; in still another embodiment there may be a discontinuous and progressively uneven lessening of said through space size from said bottom to said top of said framework in which a section having an initially equal through space size progressing along a given vertical height of said wall is followed at some point, by a section displaying a continuous progressively even lessening of through space size that is in turn supplanted by a section exhibiting a sudden change to a rapidly accelerating section of a decreasing through space size.

17. A process allowing of a remediation of a contaminated air or liquid stream:
by a passage of said contaminated air or liquid stream, at a ambient or slightly above ambient air pressure, through a contaminated air or liquid stream inlet into an inlet manifold of a vertically standing, radial flow stream remediation plenum then in a radial flow direction through a pair of concentrically arranged media support frameworks of differing diameters, a smaller inner framework and a larger outer framework;
said support frameworks comprising in part a basket weave, diamond shape lattice pattern framework wall component, and which said framework walls further comprise a series of openings or through spaces, said through spaces being found in a location between each of said diamond shaped lattice pattern components of said woven diamond shaped lattice sections;
said framework components comprising a fixedly sandwich formed from a central layer of corrosion resistant plastic screening situated between a superimposed internal layer and an external layer of a Fiberglass Reinforced Plastic (FRP) material; a total through space of said combined screen and said FRP wall materials comprising an approximate 34 percent of a total surface area of said framework walls;
following said movement of said contaminated stream into said inlet manifold of said plenum, said stream passes in a radial flow direction through said outer framework wall and into a media containment section containing a media, said media comprising a granular porous substrate media such as activated charcoal, or a organic media such as wood chips or lava rock;
following a passage of said stream through said media, said stream, continues in a radial direction centrally through said inner framework wall and into a remediated stream outlet manifold of said plenum; said stream now comprising a remediated stream, which said remediated stream next makes an exit into the environment through a remediated stream outlet
